(19) United States
(12) Patent Application Publication
(10) Pub. No.: US 2011/0099052 A1
(43) Pub. Date: Apr. 28, 2011

(54) AUTOMATIC CHECKING OF EXPECTATION-FULFILLMENT SCHEMES

(75) Inventors: Caroline BRUN, Grenoble (FR); Caroline HAGÈGE, Grenoble (FR)

(73) Assignee: Xerox Corporation, Norwalk, CT (US)

(21) Appl. No.: 12/607,568

(22) Filed: Oct. 28, 2009

(51) Int. Cl. G06Q 10/00; G06F 17/27; G06N 5/02

(52) U.S. Cl. 705/7.38; 704/9; 706/54; 704/E15.018; 704/275; 706/58

(57) ABSTRACT

A system, apparatus, method, and computer program product encoding the method are provided for expectation fulfillment evaluation. The system includes a natural language processing component that extracts sets of normalized tasks from an input expectation document and an input fulfillment document. A task list comparison component compares the two sets of tasks and identifies each match between a normalized task in the first set and a normalized task in the second set, each normalized task in the first set which has no matching task in the second set, and each normalized task in the second set which has no matching task in the first set. A report generator outputs a report based on the comparison. The report may further include one or more of statistics generated from the comparison, information on an opinion generated by opinion mining a third document, and as a list of the normalized tasks and an indication of whether the tasks were fulfilled, derived from analysis of temporal expression in the two documents. The system may be implemented as software in memory by an associated computer processor.

### CROSS REFERENCE TO RELATED PATENTS AND APPLICATIONS

The following references, the disclosures of which are incorporated in their entireties by reference, are mentioned:

U.S. application Ser. No. 12/484,569, filed Jun. 15, 2009, entitled NATURAL LANGUAGE INTERFACE FOR COLLABORATIVE EVENT SCHEDULING, by Caroline Brun, et al.; and

U.S. application Ser. No. 12/474,500, filed May 29, 2009, entitled NUMBER SEQUENCES DETECTION SYSTEMS AND METHODS, by HervéDejean.

### BACKGROUND

The exemplary embodiment relates to a computer implemented system and method for assessing the fulfillment of a set of expectations by comparing text documents in natural language which describe the expectations and fulfillments respectively, but do not have a direct one-to-one layout correspondence. It finds particular application in the context of assessing the fulfillment of personal objectives and will be described with particular reference thereto, although it is to be appreciated that it is applicable to a wide variety of applications

### Incorporation by Reference

The following references, the disclosures of which are incorporated herein in their entireties by reference, are mentioned:

U.S. Pub. No. 2009/0204596, published Aug. 13, 2009, entitled SEMANTIC COMPATIBILITY CHECKING FOR AUTOMATIC CORRECTION AND DISCOVERY OF NAMED ENTITIES, by Caroline Brun, et al., discloses a computer implemented system and method for processing text. Partially processed text, in which named entities have been extracted by a standard named entity system, is processed to identify attributive relations between a named entity or proper noun and a corresponding attribute. A concept for the attribute is identified and, in the case of a named entity, compared with the named entity's context, enabling a confirmation or conflict between the two to be determined. In the case of a proper name, the attribute's context can be associated with the proper name, allowing the proper name to be recognized as a new named entity.

U.S. Pub. No. 2005/0138556, entitled CREATION OF NORMALIZED SUMMARIES USING COMMON DOMAIN MODELS FOR INPUT TEXT ANALYSIS AND OUTPUT TEXT GENERATION, by Caroline Brun, et al., discloses a method for generating a reduced body of text from an input text by establishing a domain model of the input text, associating at least one linguistic resource with the domain model, analyzing the input text on the basis of the at least one linguistic resource, and based on a result of the analysis of the input text, generating the body of text on the basis of the at least one linguistic resource.

U.S. Pat. No. 7,058,567, issued Jun. 6, 2006, entitled NATURAL LANGUAGE PARSER, by Aït-Mokhtar, et al., discloses a parser for syntactically analyzing an input string of text. The parser applies a plurality of rules which describe syntactic properties of the language of the input string.

U.S. Pat. No. 6,202,064, issued Mar. 13, 2001, entitled Linguistic search system, by Julliard, discloses a method of searching for information in a text database which includes receiving as input a natural language expression, converting the expression to a tagged form of the natural language expression, applying to the tagged form, one or more grammar rules of a language of the natural language expression, to derive a regular expression based on the at least one word and the part of speech tag, and analyzing a text database to determine whether there is a match between the regular expression and a portion of the text database.

U.S. Pub. No. 2002/0116169, published Aug. 22, 2002, entitled METHOD AND APPARATUS FOR GENERATING NORMALIZED REPRESENTATIONS OF STRINGS, by Aït-Mokhtar, et al., discloses a method which generates normalized representations of strings, in particular sentences. The method, which can be used for translation, receives an input string. The input string is subjected to a first operation out of a plurality of operating functions for linguistically processing the input string to generate a first normalized representation of the input string that includes linguistic information. The first normalized representation is then subjected to a second operation for replacing linguistic information in the first normalized representation by abstract variables and to generate a second normalized representation.

U.S. Pub. No. 2007/0179776, published Aug. 2, 2007, entitled LINGUISTIC USER INTERFACE, by Frédérique Segond and Claude Roux, discloses a system for retrieval of text. The system identifies grammar rules associated with text fragments of a text string that is retrieved from an associated storage medium, and retrieves text strings from the storage medium which satisfy the grammar rules. A display displays retrieved text strings. A user input device in communication with the processor enables a user to select text fragments of the displayed text strings for generating a query. Grammar rules associated with the user-selected text fragments are used by the system for retrieving text strings from the storage medium which satisfy the grammar rules.

### BRIEF DESCRIPTION

In accordance with one aspect of the exemplary embodiment, an apparatus includes a system for expectation fulfillment evaluation stored in memory. The system includes a natural language processing component that extracts a first set of normalized tasks from an input expectation document and extracts a second set of normalized tasks from an input fulfillment document. A task list comparison component compares the first and second sets of tasks and identifies each match between a normalized task in the first set and a normalized task in the second set, each normalized task in the first set which has no matching task in the second set, and each normalized task in the second set which has no matching task in the first set. A report generator outputs a report based on the comparison. A processor in communication with the memory implements the system.

In accordance with another aspect a method for expectation fulfillment evaluation is provided. The method includes natural language processing an input expectation document to extract a first set of normalized tasks and an input fulfillment document to extract a second set of normalized tasks, comparing the first and second sets of normalized tasks to identify for each normalized task in the first set, whether there is a matching normalized task in the second set and for each normalized task in the second set, whether there is a matching normalized task in the first set, and outputting a report based on the comparison. In the method, one or more of the processing, comparing, and outputting may be implemented by a computer processor.

In another aspect, a method for generating a report summarizing an employee's performance is provided. The method includes natural language processing an input employee objectives document, the objectives document describing tasks to be performed in an appraisal period, to extract a first set of normalized tasks, natural language processing an input employee appraisal document, the appraisal document describing tasks performed in the appraisal period, to extract a second set of normalized tasks, and natural language processing an input comments document, the comments document including comments on the employee's performance in the appraisal period, to extract an opinion from the comments document. The method further includes comparing the first set of normalized tasks with the second set of normalized tasks, including: identifying each normalized task from the first list which has a corresponding matching normalized task in the second list and for which their deadlines are compatible, identifying each normalized task from the first list which has a corresponding matching normalized task in the second list and for which their deadlines are not compatible, identifying each normalized task from the first list which has no corresponding matching normalized task in the second list, and identifying each normalized task from the second list which has no corresponding matching normalized task in the first list. Statistics are generated, based on the comparing. A report is generated, based on the statistics and extracted opinion. Optionally, the method includes providing for input of user comments to the report. The report incorporating any input user comments is output.

### BRIEF DESCRIPTION OF THE DRAWINGS

FIG. 1 is a functional block diagram of an apparatus including a system for expectations-fulfillment evaluation in accordance with one aspect of the exemplary embodiment;

FIG. 2 is a flow diagram of a method for expectations-fulfillment evaluation in accordance with another aspect of the exemplary embodiment;

FIG. 3 illustrates part of the method of FIG. 2;

FIG. 4 illustrates exemplary expectations and fulfillment documents to be processed by the system;

FIG. 5 illustrates an exemplary comments documents to be processed by the system;

FIG. 6 illustrates exemplary task lists which may be generated from the input documents of FIG. 4; and

FIG. 7 illustrates an exemplary report of the type which may be generated by the system.

### DETAILED DESCRIPTION

A system apparatus and method are disclosed for comparing text documents with different layouts to determine whether expectations (e.g., characteristics or requirements) specified in one document have been fulfilled, based on a textual analysis of a second or more of the documents. The exemplary system uses several natural language components in order to verify automatically the adequacy between two documents corresponding respectively to 1) a list of requirements/characteristics and 2) a list of fulfillment of these requirements/characteristics. The system may also analyze free textual comments expressing an opinion about one or both of the two lists. The different documents are automatically analyzed using natural language components such as fact extraction, normalization, temporal analysis and opinion mining, in order to produce a report assessing the degree of fulfillment of the expectations together with the general opinion expressed by the comments.

The exemplary natural language processing (NLP)-based system automatically verifies the compatibility between two documents corresponding respectively to requirements and fulfillment of these requirements. The first document contains a textual list of expectations. The second document contains a textual list expressing the fulfilled expectations. The exemplary system also analyses natural language comments in third document expressing opinions about the other two documents.

The exemplary system and method provide an automatic way to check if the expectations described in the first document have been met accordingly to the second document. This can be presented in a report which summarizes to what extent the expectations are met, and what is the general opinion given by the additional written comments.

The system finds application in a wide range of situation and contexts. By way of example, the system and method are described in terms of an employee's annual evaluation process. This often involves a comparison of the objectives set by/for the employee at the beginning of the appraisal period embodied in an “objectives” document, with an “achievements” document, prepared by the employee or supervisor, describing the employee's achievements during the appraisal period. There may also be an “opinions” document which provides a supervisor's opinion on employee performance during the appraisal period. These documents rarely follow the same format and often use acronyms or other synonymous descriptions of the projects undertaken. The exemplary system provides a very good auxiliary tool for evaluating whether the objectives have been effectively performed.

Another application for the system and method is in the analysis of comparative tests on products. The experts analysis of the products may be retrieved from one source, such as magazine articles or manufacturers literature, while the opinions of users on the products may be found elsewhere, such as Internet sites selling the products, on Internet blogs, or the like.

Project evaluations or assessments (such as European or ANR projects) are other applications where the system and method may be used. Typically, reviewers are asked to fill in structured templates about the characteristics of the projects and then add written comments about these characteristics.

The system takes as input a set of documents (e.g., 2, 3, or more documents), a first one containing a structured list of expectations (e.g., requirements or characteristics), a second one containing a structured list corresponding to the assessments of the requirements or characteristics, and one or more additional documents commenting, in free text, on the different points described in the two structured documents.

Different types of linguistic processing are applied on this input. The two first documents are analyzed by fact extraction and normalization along with temporal processing (if needed), in order to extract a normalized version of the requirements and assessment of these requirements, enabling a comparison between them. The third document is analyzed by an opinion mining component to extract the opinion carried about the other two documents.

In the case of the appraisal example, the first (“objectives”) document can be for example the annual work plan (goals) that an employee creates in agreement with management and which is usually done at the beginning of the appraisal period (e.g., each year). The second (“appraisal”) document is created at or near the end of the appraisal period, i.e., after the creation of the objectives document. It describes effective performance of this employee. This is a common practice in many companies where, at the end of the year, employees have to describe the work that they have done, which may include reference to some or all the objectives as well as any additional projects undertaken. This document, or a third document, may additionally or alternatively contain the comments of the manager, who expresses his or her opinion regarding the work that has been achieved. The system analyzes each of the documents in order to determine to what extent the second one is an instantiation of the expectations described in the first one, extracts the opinion carried in the comments, and produces, based on this analysis, a report in which for each task described in the first document, the degree of achievement is given.

Because company goals may change over the course of a year, employees may change, unexpected new tasks may arise, an employee may be ill and as a consequence unable to complete his work, and because not all tasks are of equal importance, the final report may rely at least in part on a manual interaction, in order to add explanations and justifications about the possible mismatches between the tasks.

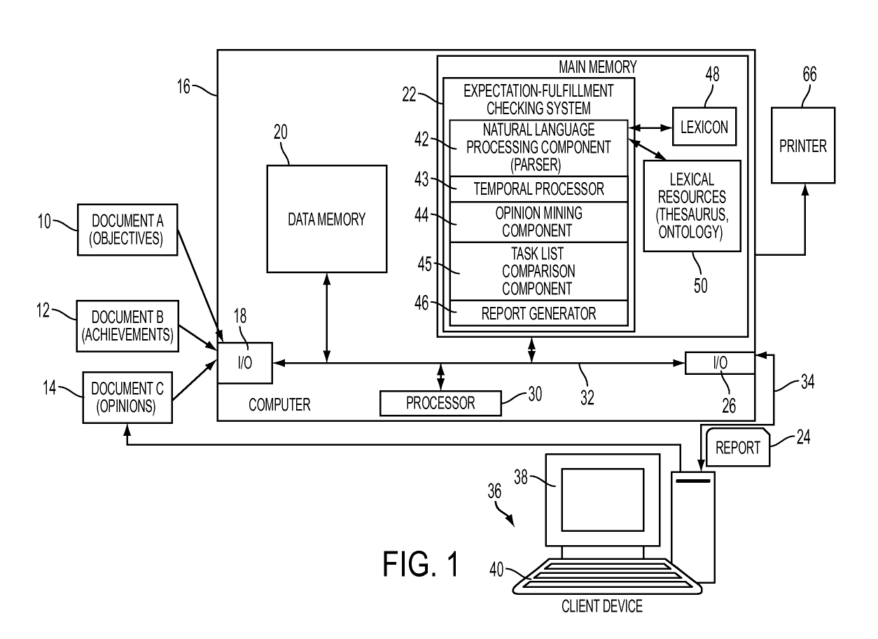

FIG. 1 illustrates an exemplary apparatus hosting a system which may be used performing the method described herein.

Documents A, B, C of different formats, identified as 10, 12, and 14, are provided. Documents A and B may be structured or semi-structured documents in electronic format which list the expectations (here, the employee's goals or objectives, e.g., summarizing the tasks to be performed) and achievements (which may include fulfillment of some or all of the expectations as well as any additional achievements), respectively, while Document C includes free text comments on the achievements. While documents A and B may have some structure, the structure alone is not sufficient to map each task in list A with a corresponding task in list B. Further, not all tasks in document A will necessarily have a corresponding task in B and vice versa. Thus, natural language processing of the documents is employed to extract the tasks, normalize them, and identify matching ones.

The documents are input to a computing device 16, which may include two or more linked computing devices (referred hereto generally as a “computer”) via an input component 18 of the computer and stored in computer memory 20, here illustrated as data memory. Input component can be a wired or wireless network connection to LAN or WAN, such as the Internet, or other data input port, such as a USB port or disc input. Documents may be in any suitable electronic form, such as text documents (e.g. Word™ or Excel™), image documents (e.g., pdf, jpeg), or a combination thereof. In the case of image documents, text may be extracted using optical character recognition (OCR) processing by a suitable OCR processor (not shown).

The computer 16 hosts a system 22 for expectation-fulfillment checking (the “system”), which processes the stored documents 10, 12, 14 and outputs a report 24, based thereon, which may be stored in computer memory and/or output from the computer 16 via an input/output component 26 (which may the same or separate from the input component 18). The exemplary system 22 includes software instructions stored in computer memory, such as main memory 28, which are executed by an associated computer processor 30, such as the computer's CPU. Components of the computer 16 are linked by a data/control bus 32.

User inputs to the system may be received via the input/output component 26 which may be linked by a wired or wireless link 34 to a client computing device 36. The link 34 may connect to the client device to the computer 16 via a LAN or WLAN, such as the Internet. Client device 36 includes a display 38 for displaying a draft report, and a user input device 40, such as a keyboard, keypad, touch screen cursor control device, combination thereof, or the like, by means of which the user can add comments to the report. The client device may include a processor and memory, analogous to computer 16.

The illustrated system 22 includes a number of text processing components, including a natural language processing component or parser 42, which performs linguistic processing on the input documents and generates a task list for each document, a temporal processing component 43, which may form a part of the parser and which identifies temporal expressions for tasks identified in the input documents, an opinion mining component 44, which mines the third document 14 for an opinion, a task list comparison component 45, which receives the output of the natural language processing component 42 and temporal processing component 43, and compares the normalized task lists and associated temporal expressions, and a report generator 46, which generates a report 24 in human readable form, based on the output of the comparison component 45, and optionally any user inputs.

The parser 42 may rely on data sources, which may be stored locally (one the computer) or remotely) such as a general lexicon 48, which indexes conventional words and phrases according to their morphological forms, and company/domain lexical resources 50, which may be in the form of a thesaurus and/or ontology. The thesaurus may index various company acronyms, shortened forms for project names according to normalized forms. The ontology relates sub-projects to main project names, and the like.

In some embodiments, the parser 42 comprises an incremental parser, as described, for example, in above-referenced U.S. Pat. No. 7,058,567, by Aït-Mokhtar, et al., in U.S. Pub. Nos. 2005/0138556 and 2003/0074187, the disclosures of which are incorporated herein in their entireties by reference, and in the following references: Aït-Mokhtar, et al., “Incremental Finite-State Parsing,” Proceedings of Applied Natural Language Processing, Washington, April 1997; Aït-Mokhtar, et al., “Subject and Object Dependency Extraction Using Finite-State Transducers,” Proceedings ACL'97 Workshop on Information Extraction and the Building of Lexical Semantic Resources for NLP Applications, Madrid, July 1997; Aït-Mokhtar, et al., “Robustness Beyond Shallowness Incremental Dependency Parsing,” NLE Journal, 2002; Aït-Mokhtar, et al., “A Multi-Input Dependency Parser,” in Proceedings of Beijing, IWPT 2001; and Caroline Brun and Caroline Hagège, “Normalization and paraphrasing using symbolic methods” ACL: Second International workshop on Paraphrasing, Paraphrase Acquisition and Applications, Sapporo, Japan, Jul. 7-12, 2003. One such parser is the Xerox Incremental Parser (XIP), which, for the present application, may have been enriched with additional processing rules to facilitate the extraction of references to tasks and temporal expressions. Other natural language processing or parsing algorithms can be used.

The exemplary parser 42 may include includes various software modules executed by processor 30. Each module works on the input text (of documents A, B, and C), and in some cases, uses the annotations generated by one of the other modules, and the results of all the modules are used to annotate the text. The exemplary parser allows deep syntactic parsing. This allows syntactic relations between text elements, such as between words or groups of words, such as a subject-object relationship, an object-verb relationship, and the like. The exemplary XIP parser extracts not only superficial grammatical relations in the form of dependency links, but also basic thematic roles between a predicate (verbal or nominal) and its arguments. For syntactic relations, long distance dependencies are computed and arguments of infinitive verbs are handled. For example, the parser may identify syntactic relations between text elements, such as between words or groups of words, such as a subject-object relationship, an object-verb relationship, and the like. See Brun and Hagege for details on deep linguistic processing using XIP. The deeper syntactic analysis performs first a simple syntactic dependency analysis and then a deep analysis. As part of the parsing, the parser 42 may resolve coreference links (anaphoric and/or cataphoric), such as identifying the named entity which the word “he” or “she” refers to in the text as well as identifying normalized forms of named entities, such as project names and the like, through access to the specialized ontology 50.

Computers 16, 36 may be in the form of one or more general purpose computing device(s), e.g., a desktop computer, laptop computer, server, and/or dedicated computing device(s). The computers may be physically separate and communicatively linked as shown, or may be integrated into a single computing device.

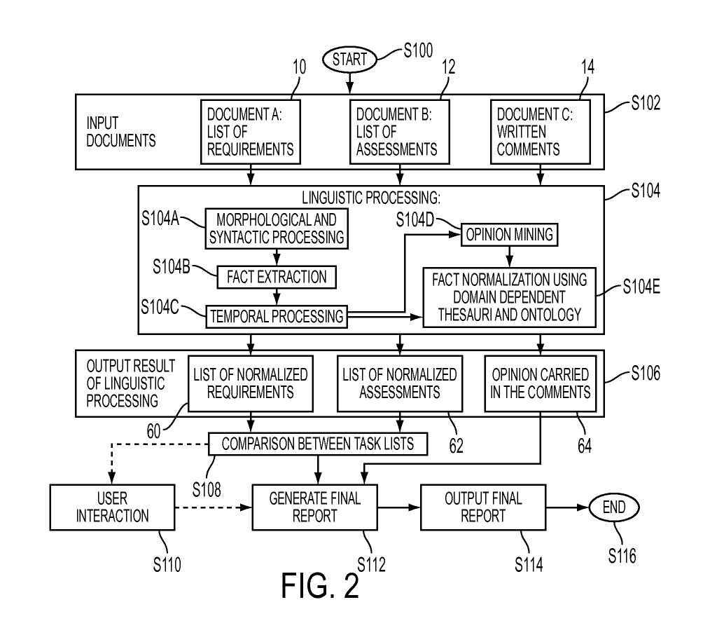

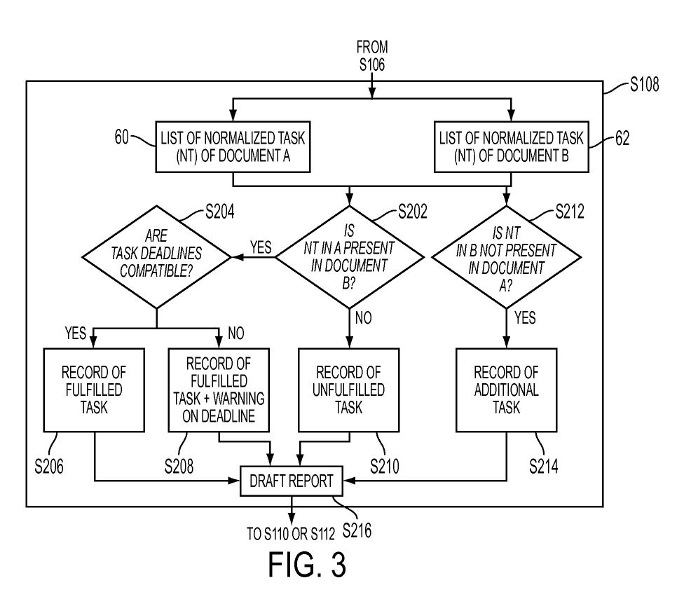

The digital processor 30, in addition to controlling the operation of the computer 16, executes instructions stored in memory 28 for performing the method outlined in FIGS. 2 and 3. The processor 30 can be variously embodied, such as by a single-core processor, a dual-core processor (or more generally by a multiple-core processor), a digital processor and cooperating math coprocessor, a digital controller, or the like.

The computer memories 20, 28 may represent any type of tangible computer readable medium such as random access memory (RAM), read only memory (ROM), magnetic disk or tape, optical disk, flash memory, or holographic memory. In one embodiment, the memory 20, 28 comprises a combination of random access memory and read only memory. In some embodiments, the processor 30 and main memory 28 may be combined in a single chip.

The term “software” as used herein is intended to encompass any collection or set of instructions executable by a computer or other digital system so as to configure the computer or other digital system to perform the task that is the intent of the software. The term “software” as used herein is intended to encompass such instructions stored in storage medium such as RAM, a hard disk, optical disk, or so forth, and is also intended to encompass so-called “firmware” that is software stored on a ROM or so forth. Such software may be organized in various ways, and may include software components organized as libraries, Internet-based programs stored on a remote server or so forth, source code, interpretive code, object code, directly executable code, and so forth. It is contemplated that the software may invoke system-level code or calls to other software residing on a server or other location to perform certain functions.

With reference now to FIGS. 2 and 3, a method for expectation fulfillment checking is shown. In the exemplary method, linguistic processing is performed on the different input texts 10, 12, 14. The expectation text(s) 10 and the achievement/comment text(s) 12 are normalized in order to be compared. The written comments in text 14 are analyzed by opinion mining.

Referring to FIG. 2, the method begins at S100.

At S102, documents 10, 12, 14 to be processed by the system 22 are input and stored in memory 20. Each document includes text in a common natural language, such as English or French, although systems 22 which process documents in different natural languages, e.g., by machine translation of one or more of the documents, are also contemplated.

At S104, the text of documents 10, 12, 14 is natural language processed. The processing may include the following steps:

At S104A, each input text 10, 12, 14 is analyzed by the parser 42. In general, the parser performs a sequence of processing steps, some of which may be iterative. For a computer, a document is above all a simple sequence of characters, without any notion what a word or a number is. The first step in parsing is to transform this sequence of characters into an ordered sequence of tokens, where a token is a sub-sequence of characters. A tokenizer module of the parser identifies the tokens in a text string, such as a sentence or paragraph, for example, identifying the words, numbers, punctuation, and other recognizable entities in the text string. For example, in a suitable approach, each word bounded by spaces and/or punctuation is defined as a single token, and each punctuation mark is defined as a single token.

Lexical or morphological processing is then performed on the tokens for each identified sentence by the parser. In particular, features from a list of features, such as indefinite article, noun, verb, etc., are associated with each recognized word or other text fragment in the document 10, 12, 14 without considering surrounding context of the token, that is, without considering adjacent tokens, e.g., by retrieving information from the general lexicon 48. Some words may have more than one label. The morphological analysis may be performed with a finite-state lexicon or lexicons. A finite-state lexicon is an automaton which takes as input a token and yields the possible interpretations of that token. A finite-state lexicon stores thousands of tokens together with their word forms in a very compact and efficient way. The morphological processing may also include identifying lemma (normalized) forms and/or stems and/or morphological forms of words used in the document and applying of tags to the respective words.

After the lexical processing, the ordered sequence of now-labeled tokens may undergo syntactical analysis. While the lexical analysis considered each token in isolation, the syntactical analysis considers ordered combinations of tokens. Such syntactical analysis may unambiguously determine the parts of speech of some tokens which were ambiguous or unidentified at the lexical level and multi-word constructions (see, e.g., U.S. Pat. No. 6,405,162, incorporated herein by reference in its entirety). Syntactic patterns, evidencing relations between words are identified, such as subject-object, subject-verb, etc relationships. Some normalization of the processed text may also be performed at this stage, which may include accessing the domain-specific lexicon 50 to identify normalized forms of company-specific terms.

At S104B, facts are extracted from the processed text. This may be performed using fact extraction rules written on top of the normal parser rules. The fact processing may include first detecting a set of relevant tasks for each document (the tasks which the employee is expected to fulfill in Document A and the tasks which are discussed in Document B). Any structure in the document, such as numbered or spaced/indented paragraphs and sub-paragraphs, may be exploited, if available, in the identification of tasks.

One object of this step is to have tasks in a normalized format so that it is possible to match tasks in Document A with corresponding tasks in Document B and identify any additional tasks in Document B which are not referred to in Document A. Step S104B is comparable to standard fact extraction methods, and in order to be more accurate, a domain vocabulary and ontology can be accessed via the specialized lexicon 50. For example, if the documents concern an employee's work plan in a given company, a specialized vocabulary and thesaurus dealing with the activities of this company may be provided. Techniques for fact extraction include named entities extraction, coreference resolution, and relations between entities extraction. See, for example, above-mentioned U.S. Pub. No. 2007/0179776, which discloses NLP based methods for fact extraction, and Marius Pasca, Dekang Lin, Jeffrey Bigham, Andrei Lifchits, and Alpa Jain. Organizing and Searching the World Wide Web of Facts—Step One: the One-Million Fact Extraction Challenge. In proceedings of the 16th International World Wide Web Conference (WWW2007), Banff, Alberta, Canada.

At S104C, temporal processing is performed. The purpose of this step is to identify, where possible, a temporal expression for each task which defines the time period over which the task is to be performed or from which it can be inferred. The temporal processing component 43, which may be a module of the parser 42 or a separate software component, is applied in order to identify those tasks which are to be performed within a given time period. Several methods for temporal processing are available which may be used herein. This may include extracting temporal expressions. A temporal expression can be any piece of information that describes a time or a date, usually in the future, such as “this year,” “Q1 2010,” “end of February” as well as specific references to dates and times, such as “by 5/16/10,” and the like. The tagging and typing of temporal expressions may be performed using a method similar to that outlined in the TimeML standard for representing temporal expressions (see Saurí, R., Littman, J., Knippen, B., Gaizauskas, R., Setzer, A., Pustejovsky, J.: TimeML Annotation Guidelines (2006), available at http://www.timeml.org/site/publications/timeMLdocs/annquide 1.2.1.pdf). Temporal expression extraction (and normalization) methods which may be used herein are also discussed in U.S. patent application Ser. No. 12/484,569, filed Jun. 15, 2009, entitled NATURAL LANGUAGE INTERFACE FOR COLLABORATIVE EVENT SCHEDULING, by Caroline Brun and Caroline Hagège; U.S. Pub. No. 2007/0168430 published Jul. 19, 2007, entitled CONTENT-BASED DYNAMIC EMAIL PRIORITIZER, by Caroline Brun, et al., and U.S. Pub. No. 2009/0235280, published Sep. 17, 2009, entitled EVENT EXTRACTION SYSTEM FOR ELECTRONIC MESSAGES, by Xavier Tannier, et al., the disclosures of which are incorporated herein by reference in their entireties, and in C. Hagège and X. Tannier, XTM: A robust temporal processor, in Proceedings of CICLing Conference on Intelligent Text Processing and Computational Linguistics, Haifa, Israel (February 2008).

In the context of employee appraisals, temporal processing is a relatively simple and straightforward task as the year is always known (by default, it the current year, i.e., the year for which the appraisal is written) and the deadlines are generally extremely explicit, as complex referential temporal expressions are rarely used in this kind of context, or where absent, can be inferred to imply that the task may continue for the entire appraisal year and beyond. A 100% correct recognition and interpretation of deadlines in the context of task expectation/fulfillment schemes can reasonably be expected.

At S104D, opinion mining is performed, e.g., on the third document 16. S104D may include extracting the opinion carried by the written comments of the manager. In this step, the opinion mining component 44, which may be a module of the parser 42, or a separate component, may be applied to Document C, in order to provide the flavor of the manager's sentiments concerning the work achieved (positive, negative or neutral). Existing techniques for opinion mining may be applied to perform this task. Opinion mining is concerned with the opinion expressed in a document, and not directly its topic. Systems that tackle opinion mining are either machine learning based, or a combination of symbolic and statistical approaches. For example, document classification methods such as Naïve Bayes, maximum entropy and support vector machines may be applied to find document sentiment polarity. See for example, B. Pang and L. Lee and S. Vaithyanathan, “Thumbs up? Sentiment Classification using Machine Learning Techniques,” Proc. of EMNLP-02, pp. 79-86 (2002). A system based on the XIP parser, such as that designed at CELI France may also be employed herein. See, Sigrid Maurel, Paolo Curtoni, Luca Dini, “A Hybrid Method for Sentiment Analysis,” published online at www.celi-france.com/publications/celi-france_english.pdf.

Such a system may rely on a lexicon which indexes words as being associated with good, bad (and/or neutral) opinions. Then, occurrences of these words in the text document C are labeled during natural language processing (e.g., at S104A). This information is retrieved during the opinion mining stage and used to determine the overall sentiment of the manager's comments. Optionally, in S104D, grammar rules are applied which determine if the labeled word, in the context in which it is used, connotes a good (or bad) opinion. This may take into account any negation. For example the expression “the work was not good” would be flagged at S104A because it includes the opinion word “good.” However, in the context used (associated with the negation: “not”), the rules would assign a negative opinion to this expression.

At S104E, fact normalization of the processed text is also performed, which may include accessing the domain-specific thesaurus 50 to identify normalized forms of company and/or domain-specific terms. Relying on the domain dependent thesaurus and vocabulary, extracted tasks (and any associated date) are normalized. For instance, if a planned task on Document A is “delivery of Spanish Proper noun detection system for Q3” in a employee work plan for 2008, the following normalized task may be obtained: “Spanish NER System until 30/09/2008”. In this example, the vocabulary of the domain stored in thesaurus 50 enables normalization of “Spanish Proper noun detection system” as “Spanish NER system” and the temporal information “Q3” into “until 30/09/2008”. Additionally expressions used in the tasks are normalized. The parser may include a set of rules for normalization, such as determiners, forms of the verb “be,” and auxiliaries other than “can” are removed. Each of the remaining words may be replaced by its lemma form. This normalization generally results in a simplification of the text. For example, the expression: “I worked on . . . ” may have a normalized expression “work on.” While documents A and B are normalized to facilitate matching, normalization of document C is not needed, although it could be performed.

At S106, the results of the linguistic processing are output. This includes outputting two task lists 60 and 62 (derived from documents 10 and 12, respectively) corresponding to lists of normalized tasks (NTs) associated with deadlines/completion dates, where present. Each identified normalized task in each task list may have a unique task identifier. Additionally, the results 64 of opinion mining on Document C are also output.

At S108, the task lists 60 and 62 output at S106 are compared by the task list comparison component 45. For each task of list 60 generated from document A (normalized expectations) a corresponding task is searched for in task list 62 generated from document B (normalized achievements). If a match between tasks is found, then deadlines are checked and compared in order to determine if those deadlines have been respected, i.e. the work has been completed prior to any deadline. By “matching task,” it is meant that the normalized form of a task in A′s list 60 is identical or sufficiently similar to the normalized form of a task in B′s list 62 to be considered a match, taking into account that in the present case, there is a reasonable probability that most tasks in list A will have a corresponding task in list B. Assuming that the task, as represented in each document 10, 12 is properly indexed in the thesaurus, or similar expressions are used, then the normalized forms of the tasks should be easily matched.

Four situations can arise: In the first case, a normalized task (NT) from document A has a corresponding matching task in document B and the deadlines are compatible (that is, the date of achievement of the task in document B is either earlier or at the time of the deadline mentioned in document A). If no deadline is explicitly mentioned, the default considered is the end of the appraisal year (or calendar year).

In the second case, a matching task is also found in Document B but the date of achievement is later than that deadline specified in document A. In this case, this task is recorded as fulfilled with a warning about the deadline.

In the third case, a NT in Document A has no correspondence to any NT in Document B. In this case, this task is recorded as unfulfilled.

Finally, in a fourth case, a NT in Document B has no corresponding task objective in Document A; this corresponds to the case where an unexpected task has arisen during the period. This task is recorded as fulfilled and additional.

FIG. 3 shows one method by which S108 may be performed. At S202, for each normalized task in list 60, a determination is made as to whether there is a normalized task in task list 62. If so, at S204, a determination is made as to whether the deadlines are compatible. If the answer is yes, a record of the task being fulfilled is stored at S206. If the answer at S204 is no, then at S208, a record of the task being fulfilled, but not meeting the deadline is stored. Referring back to S202, if the answer is no, at S210, a record of the task being unfulfilled is stored. At S212, a determination is made as to whether a normalized task which is present in B′s task list is not present in A′s task list. If, so, at S214, a record of an additional task is stored. Steps S204-S114 are repeated, as needed, until all the NT's in lists A and B have been processed. The records stored at S206, S208, S210, and S214 are combined into a draft report at S216. The method then proceeds to S110, for verifying the draft report, or directly to S112, where the information from the draft report and opinions extracted from the comments are combined into the final report 24.

For the three cases recorded at S208, S210, and S214, i.e. problem with a deadline, task in document A not present in document B, or task in document B not present in document A, at S110 manual intervention, typically performed by the manager, at his or her own initiative or in response to a computer generated prompt, could be initiated, so that the final report is modified to add explanations about the reasons of the determined mismatch, and therefore takes into account changes in strategies and objectives. This manual intervention may also be used to correct any mistakes of the system.

At S112, the final report 24 is then composed, based on the tasks achievement checking described above together with the analysis of the manager's comments.

A first part of the report document 24 contextualizes in natural language the four possible situations of task achievements. This contextualization may be performed based on simple templates. For instance in the section “fulfilled task” if a task has been fulfilled on time we will have the template:
<normalized_task_description> has been accomplished on time
   while, for the section additional task, the following template may be used:
<normalized_task_description> has been performed by <employee_name> although it was not part of the objectives.

A second part of the final report 24 represents the general opinion of the manager extracted from the free text manager's comments together with some statistics performed by the system indicating the percentage of tasks performed the average delay for task performance etc.

At this stage of final report production, while it may be performed automatically by the system, some manual interaction is also contemplated. For example, each unfulfilled task can be first presented to the manager who can choose to skip it or to add comments, such as “employee sickness leave” or “change in strategy”. The result of this interaction may be taken into account for the computation of the final statistics.

As noted above, the resulting report 24 includes the manager's opinion, derived from opinion mining of Document C 14. To provide for generating an opinion, words or phrases corresponding to a “good opinion” may be indexed as such in the lexicon 48 or thesaurus 50, so their occurrences can be flagged when found in the manager's comments. Exemplary “good opinion” words and phrases may include “good results”, “excellent”, “high quality,” “highly appreciated,” “productive,” “very efficient,” and the like. Similarly, words or phrases corresponding to a bad opinion (such as “unsatisfactory,” “poor quality,” “below standard,” “inefficient,” “inadequate” and the like), or a neutral opinion (“average,” “standard,” “acceptable,” “adequate,” etc.) can be indexed and their occurrences in Document C labeled.

Where more than one opinion is identified, the opinion can be based on an average (e.g., mean, median, or mode) of the opinions mined from Document C. For the mode, the most popular opinion is automatically computed by counting the number of occurrences of each type of opinion and selecting the most frequent. If one type heavily outweighs the others, the overall opinion may be described as very positive (or very negative). To compute a mean opinion, positive opinions may be given a score of +1, negative opinions a score of −1, and neutral opinions a score of 0. An overall opinion may be based on the mean value, for example, an average between −0.3 and +0.3 may be assigned an opinion “neutral,” an average between +0.3 and +0.5 may be assigned an opinion “positive”, and an average above about +0.5, an opinion “very positive”. Other ways of determining an overall opinion based on the mined opinions are also contemplated.

At S114, the report is output, in digital or hardcopy form. For example the report may be output to a memory storage device, such as a database, for later analysis and review, output to the client device 36 for display, or output to a printer 66 for printing on print media, such as paper.

The method ends at S116.

The method illustrated in FIGS. 2 and 3 may be implemented in a computer program product that may be executed on a computer by a computer processor. The computer program product may be a computer-readable recording medium on which a control program is recorded, such as a disk, hard drive, or the like. Common forms of computer-readable media include, for example, floppy disks, flexible disks, hard disks, magnetic tape, or any other magnetic storage medium, CD-ROM, DVD, or any other optical medium, a RAM, a PROM, an EPROM, a FLASH-EPROM, or other memory chip or cartridge, or any other tangible medium from which a computer can read and use. Alternatively, the method may be implemented in a transmittable carrier wave in which the control program is embodied as a data signal using transmission media, such as acoustic or light waves, such as those generated during radio wave and infrared data communications, and the like.

The exemplary method may be implemented on one or more general purpose computers, special purpose computer(s), a programmed microprocessor or microcontroller and peripheral integrated circuit elements, an ASIC or other integrated circuit, a digital signal processor, a hardwired electronic or logic circuit such as a discrete element circuit, a programmable logic device such as a PLD, PLA, FPGA, Graphical card CPU (GPU), or PAL, or the like. In general, any device, capable of implementing a finite state machine that is in turn capable of implementing the flowchart shown in FIGS. 2 and 3, can be used to implement the expectation fulfillment checking method.

Without intending to limit the scope of the exemplary embodiment, the following Example describes how the method could be applied to exemplary documents.

### Example

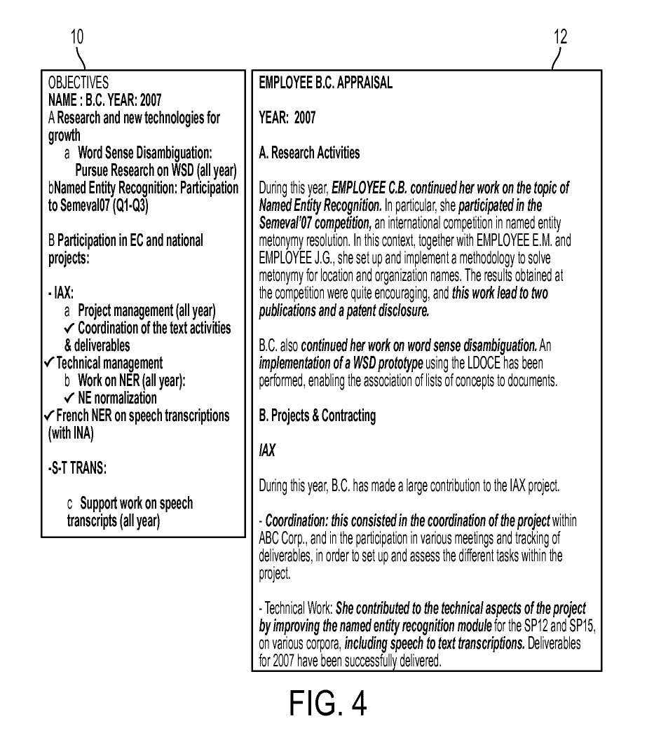

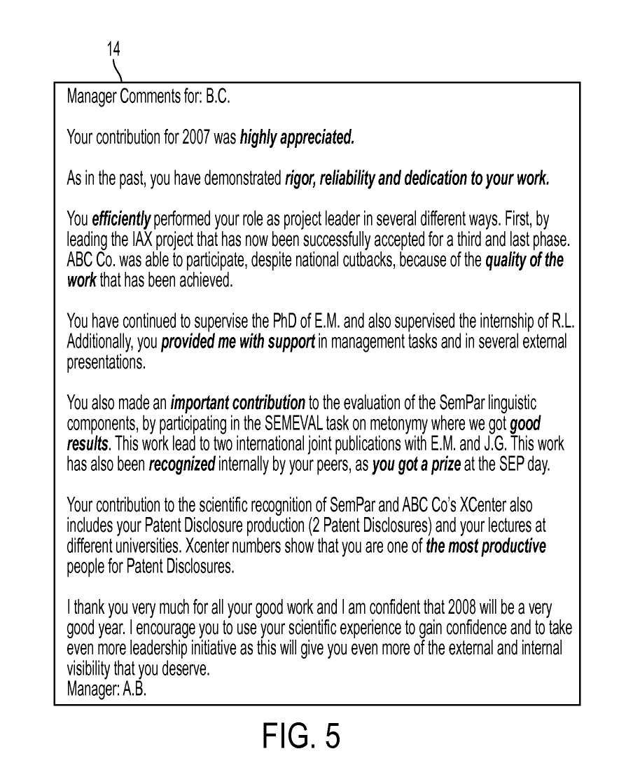

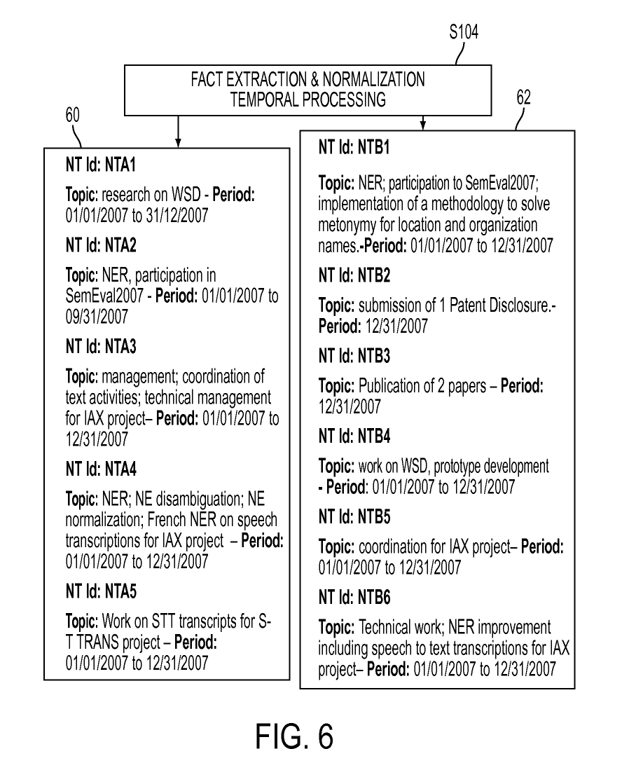

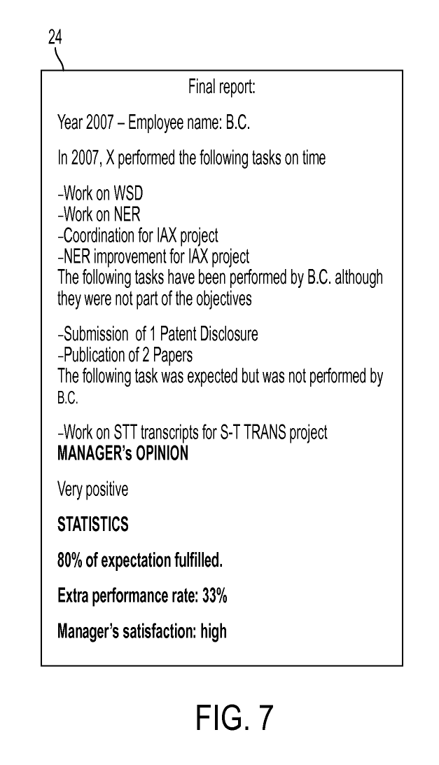

To illustrate the use of the exemplary system 22 for the validation of objectives and appraisals of employees, example input documents 10, 12, 14 have been created as shown in FIGS. 4 and 5. FIG. 6 shows the task lists 60 and 62 which could be created from example documents 10 and 12. FIG. 7 illustrates a final report 24 which could be generated, based on these documents. The documents illustrated are similar to original documents which may be generated within a company in which an employee may be requested to work on various projects during the coming year, some or all of which may have deadlines for completion of various aspects.

In FIG. 4, Sample input Document A 10 describes the objectives for an employee denoted B.C., for the calendar year 2007. Document B 12 is a sample appraisal for the same year. Since this example input is highly structured, document conversion techniques may first be applied which employ techniques for detection of numbered sequences (see, for example, above-mentioned U.S. application Ser. No. 12/474,500, entitled NUMBER SEQUENCES DETECTION SYSTEMS AND METHODS, by Hervé Dejean, the disclosure of which is incorporated herein by reference).

The textual elements enabling the creation of normalized tasks (NT) are shown in bold in both documents. Taking into account document structure, allows the project name “IAX” in Document A 10 to be propagated to each of the normalized tasks NTA3 and NTA4 in the resulting list 60.

The temporal information (such as Q1 or “all year”) is normalized to produce effective dates (taken as input, the year designated in the objectives document 10, i.e. 2007).

Normalization of the tasks enables transformation of the expression “Named Entity Recognition” and “Word Sense Disambiguation” into “NER” and “WSD,” respectively, relying on the company thesaurus 50 describing these activities.

The normalized forms of the tasks can then be matched. For example, task NT Id: NTA1 from task list 60 is matched with task NT Id: NTB4 from task list 62. Non matching tasks, such as task NT Id: NTB2 in task list 62 are also identified.

The resulting report 24 includes the manager's opinion, derived from opinion mining of the exemplary Document C 14 shown in FIG. 5. Words or phrases corresponding to a good opinion are highlighted in bold in FIG. 5. This particular employee received no negative or neutral comments in the manager's report 14 (as determined by the system), so her overall rating is computed as “very positive.”

The exemplary report 24 also includes computed statistics such as the percentage of tasks from document A which were completed (80%), as identified from document B, the extra tasks (not in document A) completed, e.g., as a percentage of all the tasks completed (33%) and a manager's satisfaction rating which is derived by opinion mining the free text comments of the manager and identifying an overall rating for the identified opinions.

In the above Example, only a single text is used as the basis for opinion mining. However, it is also contemplated that there may be several free text comments as input document(s) C. For example, in the case of project evaluation, the comments of two or more reviewers may be mined. In the context of an employee's assessment, there may be both a manager's comments and an employee's self-appraisal. In the case of a plurality of opinion sources, the final report may separately specify all the different opinion mining results. It may also note if there are discrepancies found between the different parties involved.

The exemplary system and method can provide a valuable tool in Human Resource services, helping HR managers to evaluate the work performed (reading of details in a large number of appraisals can be a very tedious task) in a quicker and assisted manner. It also can be useful in the context of the evaluation of projects (such as European projects). Another application is the analysis of product comparisons, together with users' opinions.

It will be appreciated that various of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims.

What is claimed is:

1. An apparatus comprising:
a system for expectation fulfillment evaluation stored in memory comprising:
a natural language processing component that extracts a first set of normalized tasks from an input expectation document and extracts a second set of normalized tasks from an input fulfillment document;
a task list comparison component that compares the first and second sets of tasks to identify:
each match between a normalized task in the first set and a normalized task in the second set,
each normalized task in the first set which has no matching task in the second set, and
each normalized task in the second set which has no matching task in the first set;
a report generator that outputs a report based on the comparison; and
a processor in communication with the memory which implements the system.

2. The apparatus of claim 1, wherein the system further comprises a temporal processing component that extracts temporal expressions in the expectation and fulfillment documents and associates them with the normalized tasks; and
wherein the task list comparison component determines whether a normalized task which is a match is fulfilled, based on its associated extracted temporal expressions.

3. The apparatus of claim 1, wherein the system further comprises an opinion mining component that extracts an opinion from a free text document and wherein the report generator incorporates the extracted opinion in the report.

4. The apparatus of claim 1, further comprising a domain-specific thesaurus accessible to the system, whereby tasks extracted from the input expectation document and input fulfillment document are normalized.

5. The apparatus of claim 1, wherein the expectation document describes objectives for an employee in an appraisal period and wherein the fulfillment document is an appraisal of the employee's work in the appraisal period.

6. The apparatus of claim 1 wherein the expectation and fulfillment documents are at least partially structured but do not have a one to one matching structure, and the natural language processing component utilizes the at least partial structure in generating normalized tasks.

7. The apparatus of claim 1, further comprising a user input component communicatively linked to the system for receiving a user's input to the report to be output.

8. The apparatus of claim 1, wherein the report includes performance statistics including statistics indicating the proportion of normalized tasks in the first list that are determined to have been fulfilled.

9. A method for expectation fulfillment evaluation comprising:
natural language processing an input expectation document to extract a first set of normalized tasks and an input fulfillment document to extract a second set of normalized tasks;
comparing the first and second sets of normalized tasks to identify for each normalized task in the first set, whether there is a matching normalized task in the second set and for each normalized task in the second set, whether there is a matching normalized task in the first set;
outputting a report based on the comparison.

10. The method of claim 9, further comprising extracting temporal expressions associated with at least some of the normalized tasks and normalizing the temporal expressions.

11. The method of claim 10, further comprising determining whether a normalized task in the second set that is a match is fulfilled, based on its normalized temporal expression.

12. The method of claim 11, wherein the outputting of the report includes incorporating information in the report based on the determination of fulfilled matches.

13. The method of claim 9, wherein the comparison comprises:
identifying each normalized task from the first list which has a corresponding matching normalized task in the second list and for which their deadlines are compatible;
identifying each normalized task from the first list which has a corresponding matching normalized task in the second list and for which their deadlines are not compatible;
identifying each normalized task from the first list which has no corresponding matching normalized task in the second list; and
identifying each normalized task from the second list which has no corresponding matching normalized task in the first list.

14. The method of claim 13, wherein the method further comprises:
for each identified normalized task from the first list which has no corresponding matching normalized task in the second list, generating a warning that the task has not been fulfilled.

15. The method of claim 13, further comprising computing statistics based on the matches determined to be fulfilled.

16. The method of claim 9, further comprising opinion mining a free text document to extract an opinion therefrom and incorporating information based on the extracted opinion in the report.

17. The method of claim 9, wherein the extraction of normalized tasks comprises normalizing extracted tasks based on at least one of:
information from a domain-specific thesaurus;
structure within the document from which the task is extracted;
reducing expressions to a common normalized form, and coreference resolution.

18. The method of claim 17, wherein the expectation and fulfillment documents are at least partially structured but do not have a one to one matching structure, and the normalizing of the extracted tasks includes utilizing the at least partial structure in normalizing the extracted tasks.

19. The method of claim 9, wherein the expectation document comprises tasks that an employee is expected to work on during an appraisal period, optionally with temporal expressions indicating time periods for completion of the tasks, and wherein the fulfillment document describes tasks the employee has worked on during the appraisal period, optionally with temporal expressions indicating when the tasks were completed.

20. The method of claim 9, further comprising providing for receiving a user's input to the report before it is output.

21. A computer program product in tangible form which encodes instructions which when executed by a computer, perform the method of claim 9.

22. A method for generating a report summarizing an employee's performance comprising:
natural language processing an input employee objectives document, the objectives document describing tasks to be performed in an appraisal period, to extract a first set of normalized tasks;
natural language processing an input employee appraisal document, the appraisal document describing tasks performed in the appraisal period, to extract a second set of normalized tasks;
natural language processing an input comments document, the comments document including comments on the employee's performance in the appraisal period, to extract an opinion from the comments document;
comparing the first set of normalized tasks with the second set of normalized tasks, including:
identifying each normalized task from the first list which has a corresponding matching normalized task in the second list and for which their deadlines are compatible,
identifying each normalized task from the first list which has a corresponding matching normalized task in the second list and for which their deadlines are not compatible,
identifying each normalized task from the first list which has no corresponding matching normalized task in the second list, and
identifying each normalized task from the second list which has no corresponding matching normalized task in the first list;
generating statistics based on the comparing;
generating a report based on the statistics and extracted opinion;
optionally, providing for input of user comments to the report; and
outputting the report incorporating any input user comments.
